(19) United States
(12) Patent Application Publication
(10) Pub. No.: US 2023/0325685 A1
(43) Pub. Date: Oct. 12, 2023

(54) Adapting Pretrained Classification Models to Different Domains

(71) Applicant: Adobe Inc., San Jose, CA (US)

(72) Inventors: Fabian David Caba Heilbron, Campbell, CA (US); Santiago Castro Serra, Ann Arbor, MI (US)

(73) Assignee: Adobe Inc., San Jose, CA (US)

(21) Appl. No.: 17/718,607

(22) Filed: Apr. 12, 2022

(51) Int. Cl. G06N 5/02

(52) U.S. Cl. CPC G06N 5/022

(57) ABSTRACT

A model training system is described that obtains a training dataset including videos and text labels. The model training system generates a video-text classification model by causing a model having a dual image text encoder architecture to predict which of the text labels describes each video in the training dataset. Predictions output by the model are compared to the training dataset to determine distillation and contrastive losses, which are used to adjust internal weights of the model during training. The internal weights of the model are then combined with internal weights of a trained image-text classification model to generate the video-text classification model. The video text-classification model is configured to generate a video or text output that classifies a video or text input.

### BACKGROUND

The field of computer vision pertains to automating the human visual system by having computers derive information from digital images and videos. To facilitate this automation, machine learning models are trained to perform specific visual tasks. As an example, image-text classification models are trained to detect objects depicted in a digital image and assign textual labels to each detected object. During training, labeled training data is used to demonstrate multiple examples of an object, such as hundreds of images of horses with labels indicating that each picture depicts a horse. While conventional models are able to reliably classify image objects given a sufficient amount of training examples for the objects, the conventional models are unable to classify objects not observed in training data.

This problem of observing image data not represented in a distribution of training data is known as a zero-shot problem. To address the zero-shot problem, conventional approaches implement auxiliary data that teaches an image-text classification model to learn distinguishing properties of an object. As an example, auxiliary data describing how zebras look like striped horses is useable to teach the model trained on hundreds of images of horses to recognize zebras, despite zebras not being depicted in the labeled training data. However, conventional approaches for addressing the zero-shot image classification problem do not reliably extend to video classification due to image characteristics captured by virtue of a video's temporal dimension.

### SUMMARY

A model training system is described that generates a video-text classification model configured to leverage knowledge encoded in a pretrained image-text classification model and new video knowledge such that the video-text classification model can accurately perform a wide range of video classification tasks using a relatively small training dataset. To do so, the model training system obtains a pretrained image-text classification model and tasks the pretrained image-text classification model with assigning a textual label to a plurality of unlabeled videos. The textual labels assigned to the unlabeled videos by the pretrained image-text classification model are used to train the video-text classification model.

To adapt the video-text classification model to the video domain, the model training system further obtains ground truth training data that includes videos associated with textual labels known to accurately describe visual content depicted by the video. The model training system obtains an untrained architectural copy of the pretrained image-text classification model and provides unlabeled videos and text labels as separate inputs to the untrained architectural copy model, tasking the model with predicting which of the text labels accurately describes each of the unlabeled videos. Predictions output by the model are then compared against training data to determine both contrastive and distillation losses and refine internal weights of the untrained model during training. The model training system then fuses the internal weights of the model with internal weights of the pretrained image-text classification model and applies the fused internal weights to the video-text classification model. The resulting video-text classification model is configured to accurately output video or text classifying a video or text input.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In some implementations, entities represented in the figures are indicative of one or more entities and thus reference is made interchangeably to single or plural forms of the entities in the discussion.

FIG. 1 is an illustration of a digital medium environment in an example implementation that is operable to employ a classification model and generate a label for an unlabeled video and a model training system configured to generate a video-text classification model employed by the classification system.

FIG. 2 depicts a digital medium environment showing operation of the model training system of FIG. 1 in greater detail.

FIG. 3 depicts a digital medium environment showing operation of the model training system of FIG. 1 in greater detail.

FIG. 4 depicts an example of an image-text classification model predicting labels for unlabeled videos during training of a video-text classification model.

FIG. 5 depicts an example of a video-text classification model trained by the model training system of FIG. 1 generating a label for an unlabeled video.

FIG. 6 depicts an example of a video-text classification model trained by the model training system of FIG. 1 outputting a video identified based on a text input.

FIG. 7 is a flow diagram depicting a procedure in an example implementation of generating a video-text classification model from a trained image-text classification model and using the video-text classification model to output a text label or a video for an input using the techniques described herein.

FIG. 8 illustrates an example system including various components of an example device to implement the techniques described with reference to FIGS. 1-7.

### DETAILED DESCRIPTION

In the field of computer vision, machine learning models have been trained to reliably recognize visual content depicted in still images and identify textual descriptions that describe the visual content in natural language. These conventional machine learning models are implemented to perform tasks such as automatic image labeling and text-to-image retrieval. However, conventional image-text classification models are unable to reliably adapt to video. A primary obstacle to adapting conventional image-text classification models to video occurs due to the time dimension captured by video, which is inherently absent from still digital images. For instance, in contrast to still images, video frames contain motion blur and degraded sharpness due to the capture of visual content over a period of time rather than a moment captured by a still image.

Despite the additional temporal dimension captured by a video, some conventional image-text classification models are able to output text that accurately describes visual content depicted in a video, so long as the visual content depicted in the video was similarly represented in digital images used to train the image-text classification model. For example, in a conventional supervised setting, training a conventional image-text model requires providing numerous labeled examples of a particular type of image (e.g., hundreds of pictures of a car) before the conventional image-text model can accurately categorize an unlabeled picture of a car. From this knowledge gleaned during training, a conventional image-text model might accurately classify a video of a car if the video of the car appears visually similar to the cars depicted in the training images. However, conventional image-text models cannot accurately a video that depicts visual content which was not represented in the image training dataset, which is known as a zero-shot problem.

To address the zero-shot video recognition task, some conventional methods obtain training data in the form of manually defined object attributes, attempt to infer object attributes depicted in a video, and map the inferred object attributes to the manually defined object attributes in training data. Alternatively, some conventional approaches learn word embeddings for actions depicted in video data and attempt to translate video characteristics to the word embedding space in an attempt to identify actions depicted in video data. However, these conventional approaches are limited to small training datasets relative to training datasets used to train image-text classification models, as storing, transmitting, and processing video training data requires exponentially more computational resources relative to computational resources required to store, transmit, and process image training data. Consequently, conventional methods for training video and text classification models are often limited to training datasets multiple orders of magnitude smaller than image-text training datasets. This relatively small amount of training data is significantly limiting, particularly in the context of a zero-shot application, as a resulting model trained on the small dataset is limited in its ability to glean information not represented by the training dataset.

To address these conventional shortcomings, a model training system is described that generates a video-text classification model configured to leverage knowledge encoded in a pretrained image-text classification model and new video knowledge such that the video-text classification model can accurately perform a wide range of zero-shot video classification tasks using a relatively small training dataset. To do so, the model training system obtains a pretrained image-text classification model and tasks the pretrained image-text classification model with assigning a textual label to a plurality of unlabeled videos, assuming that the textual labels assigned by the pretrained image-text classification model with describe the unlabeled videos with at least a partial degree of accuracy. Given this partial degree of accuracy, the textual labels assigned to the unlabeled videos by the pretrained image-text classification model are useable to train the video-text classification model. In this manner, the pretrained image-text classification model serves as a teacher for training the video-text classification model in a teacher-student fashion.

To adapt the video-text classification model to the video domain, the model training system further obtains ground truth training data that includes videos associated with textual labels known to accurately describe visual content depicted by the video. The model training system obtains an untrained architectural copy of the pretrained image-text classification model and provides unlabeled videos and text labels as separate inputs to the untrained architectural copy model, tasking the model with predicting which of the text labels accurately describes each of the unlabeled videos. The unlabeled videos represent both the unlabeled videos provided to the pretrained image text classification model as well as unlabeled versions of the ground truth training data. The predicted text labels output by the untrained model are thus comparable to the ground truth training dataset as well as the predictions output by the pretrained image-text classification model. The model training system leverages this comparability to determine both contrastive and distillation losses and refine internal weights of the untrained model during training. After completing a plurality of training iterations, the model is output with its refined internal weights.

To leverage the comparably vast existing knowledge of the pretrained image-text classification model, gleaned via a large training dataset of images and text labels, the model training system then fuses the internal weights of the model with internal weights of the pretrained image-text classification model. In this manner, the internal weights of the teacher model that represent knowledge in the image and text domains are fused with the internal weights of the student model that represent knowledge in the video and text domains. By using video training data generated using the pretrained image-text classification model, the model training system minimizes model drift and avoids forgetting knowledge encoded in the pretrained image-text classification model.

The resulting video-text classification model thus learns both general visual knowledge encoded in the pretrained image-text classification model together with the video-specific properties learned by the student model during training on a video dataset. The resulting video-text classification model is configured to accurately output video or text classifying a video or text input. For instance, the video-text classification model is configured to output a text label that accurately describes visual content depicted in an unlabeled video. Similarly, given a text input, the video-text classification model is configured to identify and output an unlabeled video that depicts visual content described by the text input. As yet a further example, the video-text classification model is configured to identify and output a video that depicts visual content similar to that depicted in an unlabeled video input to the video-text classification model. In this manner, the video-text classification model is configured to accurately classify both video and text in latent space, even when the video and text being classified falls outside a distribution of video and text training data utilized by the model training system.

In the following discussion, an example environment is described that is configured to employ the techniques described herein. Example procedures are also described that are configured for performance in the example environment as well as other environments. Consequently, performance of the example procedures is not limited to the example environment and the example environment is not limited to performance of the example procedures.

### Example Environment

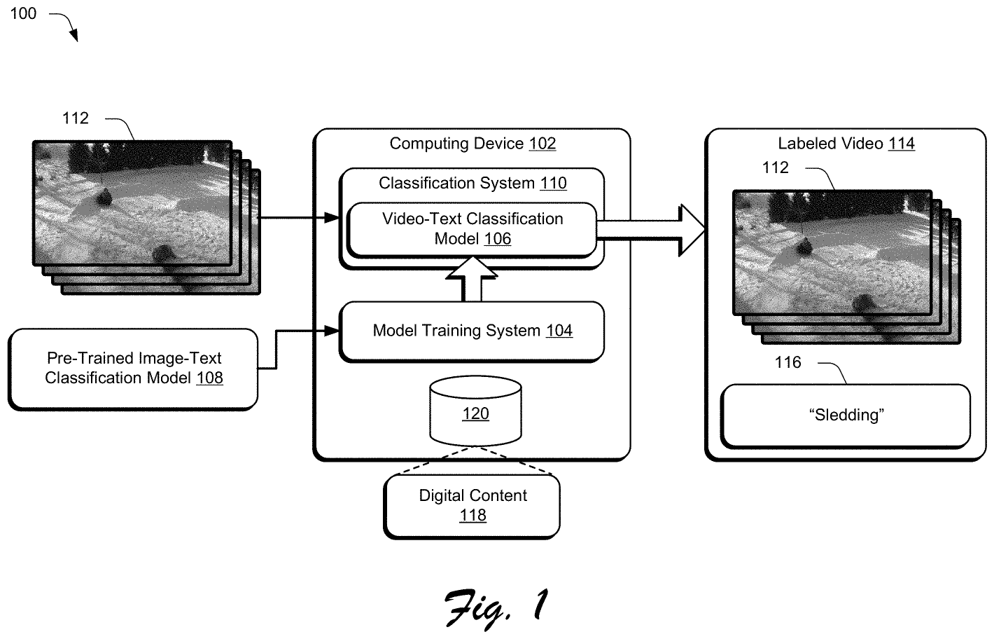

FIG. 1 is an illustration of a digital medium environment 100 in an example implementation that is operable to employ techniques described herein. The term “digital medium environment” refers to the various computing devices and resources utilized to implement the techniques described herein. The digital medium environment 100 includes a computing device 102, which is configurable in a variety of manners.

The computing device 102, for instance, is configurable as a desktop computer, a laptop computer, a mobile device (e.g., assuming a handheld or wearable configuration such as a tablet, mobile phone, smartwatch, etc.), and so forth. Thus, the computing device 102 ranges from full resource devices with substantial memory and processor resources (e.g., personal computers, game consoles) to low-resource devices with limited memory and/or processing resources (e.g., mobile devices). Additionally, although a single computing device 102 is shown, the computing device 102 is representative of a plurality of different devices, such as multiple servers utilized by a business to perform operations “over the cloud.”

The computing device 102 is illustrated as including a model training system 104. The model training system 104 is configured to generate a video-text classification model 106 from a pre-trained image-text classification model 108 using the techniques described herein. The video-text classification model 106 is representative of a model trained to analyze both digital images and text expressing natural language and represent the digital images and text in latent space. By representing both digital images and text in latent space, the pre-trained image-text classification model 108 is configured to represent each instance of a digital image or text expressing natural language as a data point, where similar data points are grouped closer together in the latent space relative to different data points. Consequently, the pre-trained image-text classification model 108 is configured to identify similarities between data points represented in the latent space (e.g., between images and text, between images and images, and between text and text).

While the pre-trained image-text classification model 108 is configured to identify similarities between images and text, the pre-trained image-text classification model 108 is not configured to reliably classify information outside of the image-text domain. For instance, the pre-trained image-text classification model 108 is not configured to reliably represent videos as data points in the latent space, and thus cannot reliably identify similarities between videos and text or videos and images. Although described herein with context to adapting the pre-trained image-text classification model 108 from a domain including digital images and text expressing natural language to a domain including videos, the techniques described herein are similarly applicable to adapting a pre-trained classification model to different domains, such as audio, numerical, and so forth.

The model training system 104 generates the video-text classification model 106 by using the pre-trained image-text classification model 108 to generate a training dataset for use in training the video-text classification model 106. To do so, the model training system 104 causes the pre-trained image-text classification model 108 to generate a pseudolabeled video dataset by providing a plurality of text labels and a plurality of unlabeled videos as input to the pre-trained image-text classification model 108. The pre-trained image-text classification model 108, being trained to output text labels for input images, interprets the unlabeled videos provided as input by the model training system 104 as images to be labeled and selects one of the plurality of text labels as a best-fit candidate for each of the unlabeled videos in accordance with its training objective. The pseudolabeled video dataset generated as a result of providing these unlabeled videos and plurality of text labels as input to the pre-trained image-text classification model 108 serves as a teaching constraint for the video-text classification model 106. As a further teaching constraint, the model training system 104 obtains a plurality of ground truth labeled videos, where each of the ground truth labeled videos includes a video manually labeled with natural language text by a human.

The model training system 104 then obtains an untrained model having a same architecture as the pre-trained image-text classification model 108. For instance, in an example implementation where the pre-trained image-text classification model 108 includes a text encoder and an image encoder, the model training system 104 obtains an untrained model having a text encoder and an image encoder. The untrained model is then trained using the unlabeled videos and text labels provided as inputs to the pre-trained image-text classification model 108 for generating the pseudolabeled videos. Outputs of the untrained model are then compared relative to the pseudolabeled videos and the ground truth labeled videos to determine a loss function that includes both contrastive and distillation losses. The loss function is then applied to the untrained model during training until a threshold number of training iterations are complete or until an output of the untrained model achieves a threshold similarity to the ground truth labeled videos. In response to completing the threshold number of training iterations or achieving the threshold similarity, convolutional weights of the pre-trained image-text classification model 108 are ensembled with the trained convolutional weights of the model trained by the model training system 104. The resulting model with ensembled convolutional weights is then output as the video-text classification model 106.

The video-text classification model 106 is useable by a classification system 110 to receive an unlabeled video 112 as input and generate a labeled video 114. For instance, in the illustrated example of FIG. 1, unlabeled video 112 includes a plurality of video frames that depict a child sledding in a snowy setting with trees in the background and a dog in the foreground. The video-text classification model 106 is configured to generate a label 116 that includes a textual description of “sledding” for the unlabeled video 112 and output the label 116 together with the unlabeled video 112 as the labeled video 114. In some implementations, the unlabeled video 112 and the labeled video 114 are representative of instances of digital content 118 maintained in a data store 120 of the computing device 102. Alternatively or additionally, the unlabeled video 112 and the labeled video 114 are representative of instances of digital content 118 stored via one or more storage devices implemented remotely from the computing device 102.

Having considered an example digital medium environment, consider now a discussion of example systems useable to generate a video-text classification model from a pre-trained image-text classification model and output a text label or a video for an input using the trained video-text classification model.

Video-Text Classification and Model Training Systems

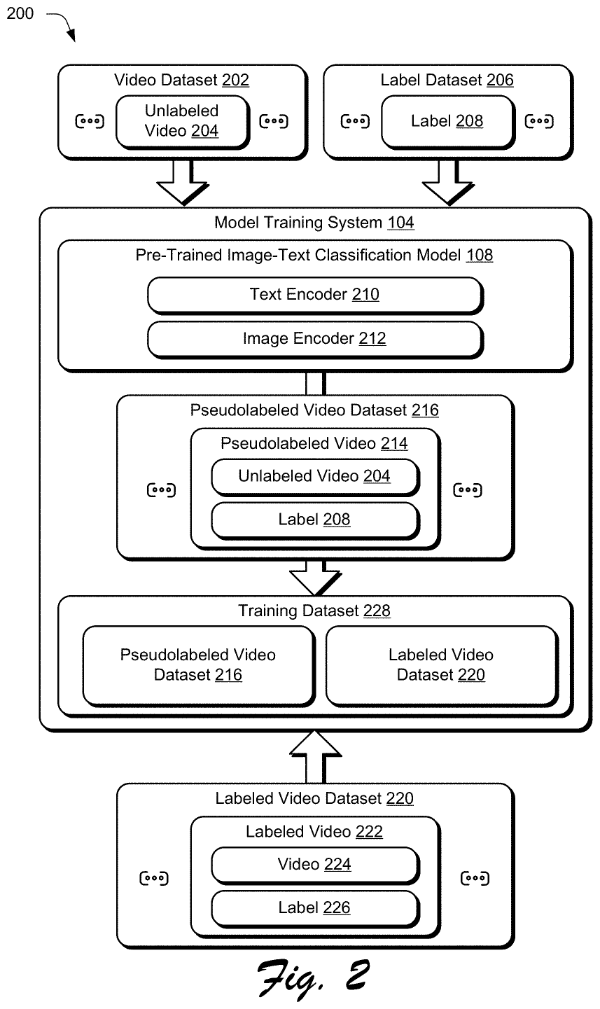

FIG. 2 depicts a digital medium environment 200 showing operation of the model training system 104 producing a training dataset for use in generating a video-text classification model.

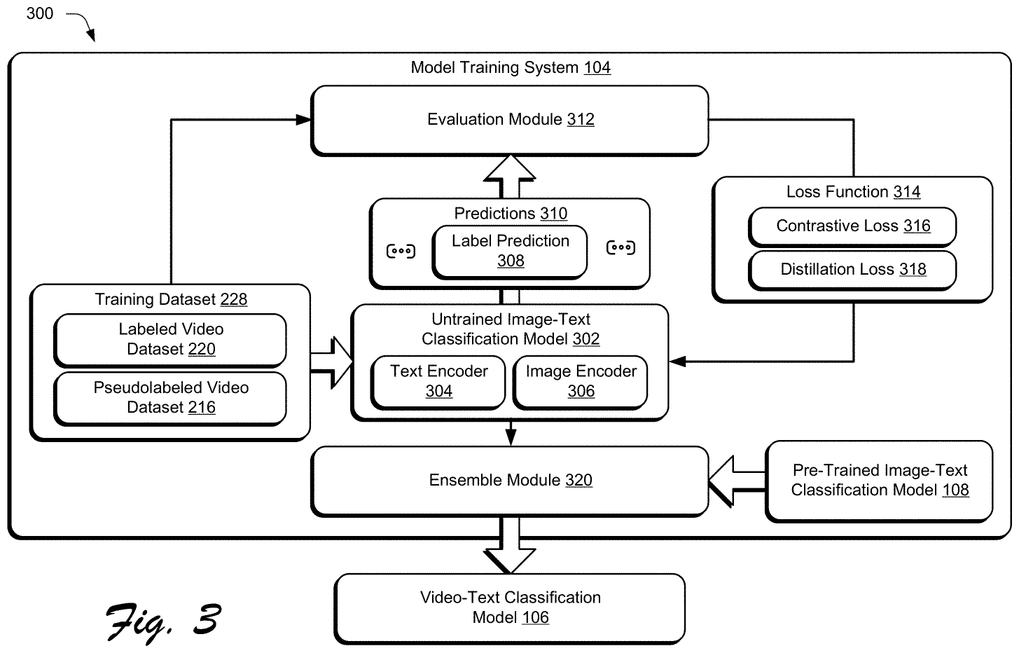

FIG. 3 depicts a digital medium environment 300 showing operation of the model training system 104 generating a video-text classification model 106.

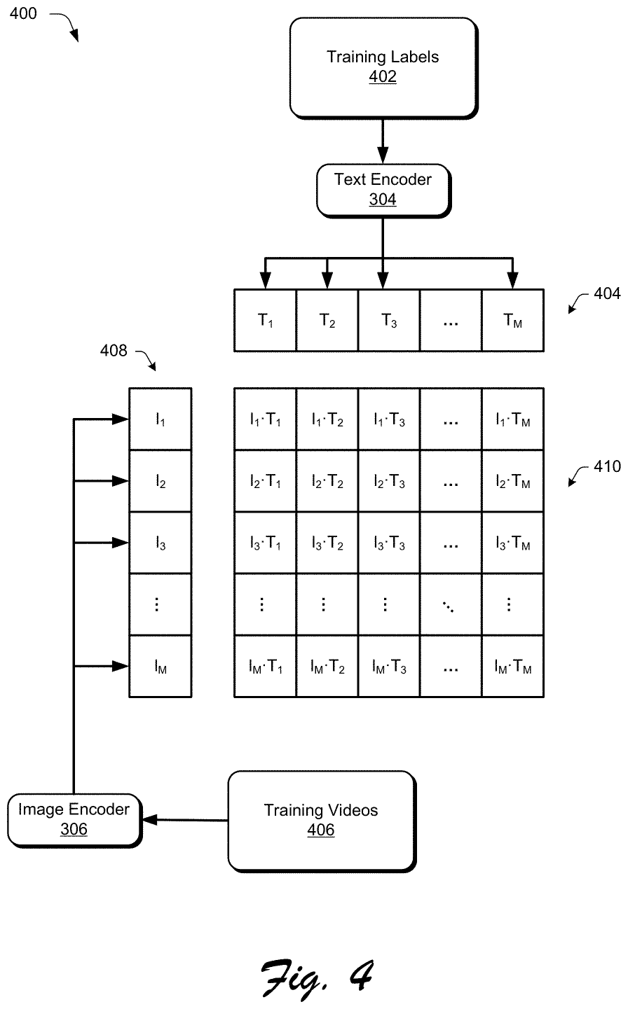

FIG. 4 depicts a digital medium environment 400 showing operation an image-text classification model predicting labels for unlabeled videos during training of a video-text classification model 106.

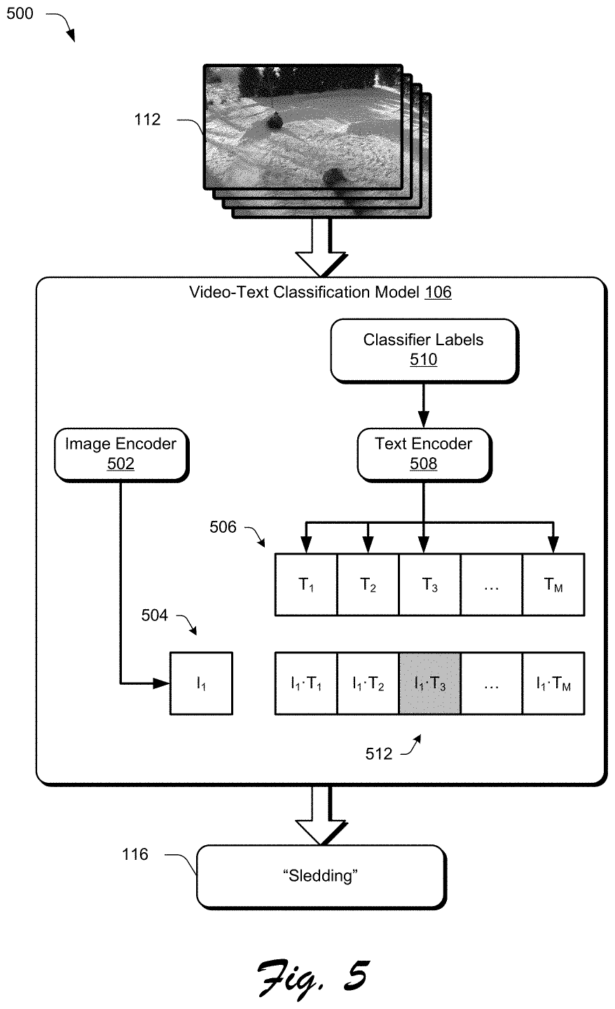

FIG. 5 depicts a digital medium environment 500 showing operation of the video-text classification model 106 trained by the model training system 104 generating a label 116 for an unlabeled video 112.

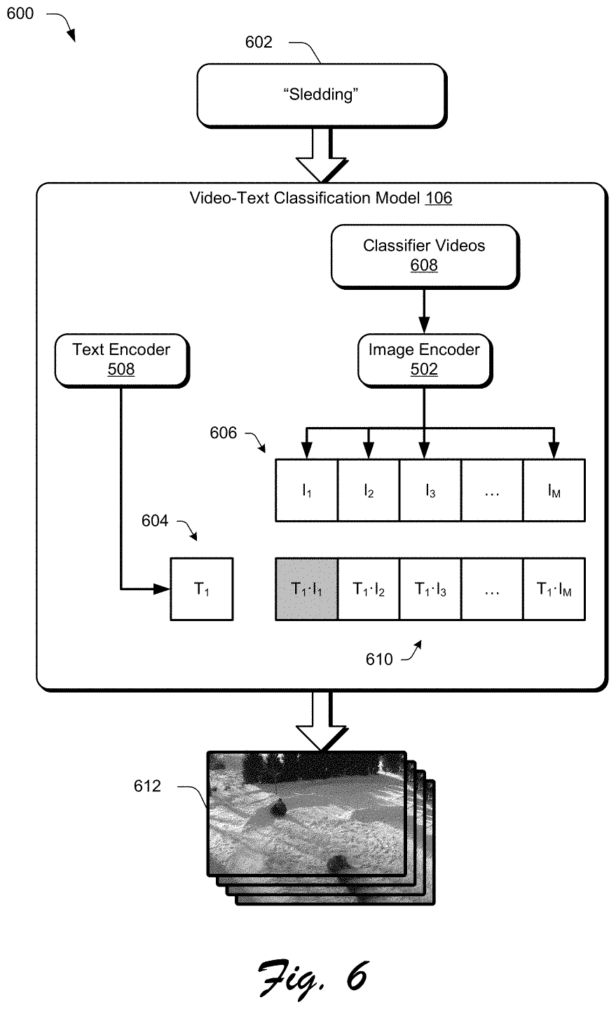

FIG. 6 depicts a digital medium environment 600 showing operation of the video-text classification model 106 trained by the model training system 104 outputting a video identified based on input text.

As illustrated in FIG. 2, the model training system 104 receives a video dataset 202 that includes a plurality of unlabeled videos 204. In implementations, each unlabeled video 204 included in the video dataset 202 is selected by the model training system 104 based on a classification objective. For instance, in an example implementation where the model training system 104 produces a video-text classification model 106 configured to identify video-depicted actions, each unlabeled video 204 depicts a human performing an action. The model training system 104 additionally receives a label dataset 206 that includes a plurality of labels 208.

The label dataset 206 is unaligned with the video dataset 202, such that no correlation exists between an unlabeled video 204 and a label 208 prior to processing by the model training system 104. In implementations, the label dataset 206 includes labels 208 selected based on a classification objective. For instance, continuing the example implementation where the model training system 104 produces a video-text classification model 106 configured to identify video-depicted actions, the label dataset 206 includes textual descriptions of actions. In some implementations, the label dataset 206 includes a different number of labels 208 than a number of unlabeled videos 204 included in the video dataset 202. Thus, the video dataset 202 and the label dataset 206 are representative of independent datasets without information describing how individual labels 208 correspond to individual unlabeled videos 204.

As part of generating a training dataset, the model training system 104 leverages the pre-trained image-text classification model 108 to process the video dataset 202 and the label dataset 206. In the illustrated example of FIG. 2, the pre-trained image-text classification model 108 is configured as having a text encoder 210 and an image encoder 212. In some implementations, the pre-trained image-text classification model 108 is representative of the Contrastive Language-Image Pre-training (CLIP) model architecture as described by Radford, et al. in “Learning Transferable Visual Models from Natural Language Supervision,” arXiv:2103.00020, 2021, the disclosure of which is hereby incorporated by reference.

During training, the text encoder 210 and the image encoder 212 are trained to predict a correct pairing of an image and text pair using a contrastive objective, as described by van den Oord, et. al in “Representation Learning with Contrastive Predictive Coding,” arXiv: 1807.03748, 2018, the disclosure of which is hereby incorporated by reference. In this manner, when an image is provided as input, the pre-trained image-text classification model 108 is configured to identify visual characteristics of the image and identify a textual label that describes the visual characteristics. In some implementations, the pre-trained image-text classification model 108 is trained on a vast dataset (e.g., over 400 million images and text descriptions), which enables the pre-trained image-text classification model 108 to accurately classify diverse ranges of image characteristics.

The model training system 104 leverages this pre-trained knowledge and tasks the pre-trained image-text classification model 108 with classifying each unlabeled video 204 included in the video dataset 202 with the labels 208 included in the label dataset 206. To do so, the model training system 104 samples a subset of N frames from each unlabeled video 204 and provides the N frames as input with the label dataset 206 to the pre-trained image-text classification model 108. N is representative of any suitable integer. In some implementations, the N frames represent contiguous frames of the unlabeled video 204. Alternatively, the N frames are not contiguous, such that during playback of the unlabeled video 204 at least one of the N frames are displayed between other ones of the N frames.

For instance, the model training system 104 samples four contiguous frames from the unlabeled video 204 and provides the four frames as input to the pre-trained image-text classification model 108. For each video frame input to the pre-trained image-text classification model 108, the image encoder 212 extracts an image representation. The pre-trained image-text classification model 108 then compares the image representation for the video frame with text representations extracted by the text encoder 210 for each label 208 in the label dataset 206 and assigns a similarity score to each video frame/text representation pair. This process is repeated for each of the N frames sampled from an unlabeled video 204, and the similarity scores for the N frames are combined using average pooling to represent similarity scores between the unlabeled video 204 and each of the labels 208. The unlabeled video 204, together with its similarity scores representing correlations with labels 208 in the label dataset 206, is then output as a pseudolabeled video 214. The model training system 104 continues this process and generates a pseudolabeled video 214 for each unlabeled video 204 included in the video dataset 202. The pseudolabeled videos 214 are aggregated into a pseudolabeled video dataset 216.

Although each pseudolabeled video 214 is illustrated in FIG. 2 as correlating a single unlabeled video 204 with a single label 208, this illustration is not limiting. For example, in some implementations the pseudolabeled video 214 is represented in the pseudolabeled video dataset 216 as a correlation of the unlabeled video 204 with only a top-scoring one of the labels 208, as determined by from processing N frames of the unlabeled video 204 using the pre-trained image-text classification model 108. Alternatively, the pseudolabeled video 214 is represented in the pseudolabeled video dataset 216 as being associated with a distribution of scores representing a correspondence of the unlabeled video 204 with each of the labels 208 represented in the label dataset 206.

Thus, the pseudolabeled video dataset 216 represents an estimation of how each unlabeled video 204 in a video dataset 202 corresponds to candidate labels 208 of a label dataset 206. However, because the pre-trained image-text classification model 108 is not trained to reliably classify video data, training a video-text classification model 106 on the pseudolabeled video dataset 216 alone would fail to produce a reliable video classification model.

The model training system 104 is further configured to obtain a labeled video dataset 220 for use in training the video-text classification model 106. The labeled video dataset 220 includes a plurality of labeled videos 222, where each labeled video 222 represents a video 224 matched with a textual label 226 describing the visual content of the video 224. In implementations, each labeled video 222 is generated manually by a human user and serves a ground truth training example for proper video classification. In some implementations, the labeled video dataset 220 is relatively smaller in comparison to a size of the pseudolabeled video dataset 216 to avoid model drift. Collectively, the pseudolabeled video dataset 216 and the labeled video dataset 220 serve as a training dataset 228 for training the video-text classification model 106.

As depicted in FIG. 3, the model training system 104 begins generating the video-text classification model 106 using an untrained image-text classification model 302. The untrained image-text classification model 302 is representative of a machine learning model having a same architecture as the pre-trained image-text classification model 108. For instance, the untrained image-text classification model 302 includes a text encoder 304 that is representative of an architectural duplicate of the text encoder 210 and an image encoder 306 that is representative of an architectural duplicate of the image encoder 212. In an example implementation, the text encoder 304 and the image encoder 306 are each configured as a VIT-B/16 transformer network initialized with the OpenAI publicly released weights, as described by Radford et al.

The videos and labels from the training dataset 228 are then provided as input to the untrained image-text classification model 302 without indication as to how different labels and videos are associated in the training dataset 228. Thus, the untrained image-text classification model 302 is unaware of ground truth labels for videos included in the labeled video dataset 220. Similarly, the untrained image-text classification model 302 is unaware of similarity scores computed by the pre-trained image-text classification model 108 as represented in the pseudolabeled video dataset 216. The untrained image-text classification model 302 is tasked with classifying each video included in the training dataset 228 using labels included in the training dataset 228. Specifically, for each video represented in the training dataset 228, the untrained image-text classification model 302 outputs a label prediction 308.

To do so, labels included in the training dataset 228 are input to the untrained image-text classification model 302 and the text encoder 304 is tasked with generating a text representation of each label. Additionally, N frames are sampled from a video included in the training dataset 228 and input to the untrained image-text classification model 302. The image encoder 306 is tasked with extracting an image representation for each video frame. The untrained image-text classification model 302 is then tasked with comparing the image representation for the video frame as extracted by the image encoder 306 with the text representations extracted by the text encoder 304. A similarity score is assigned to each video frame/text representation pair, and this process of assigning similarity scores is repeated for each of the N frames sampled from a training dataset 228 video. The similarity scores for the N frames of a training dataset 228 video are then combined using average pooling and the combined similarity scores represent a correspondence between the training dataset 228 video and the labels included in the training dataset 228.

During training, the similarity scores for different textual labels and a video included in the training dataset 228 are output by the untrained image-text classification model 302 as a label prediction 308. The model training system 104 repeats this process and causes the untrained image-text classification model 302 to generate a label prediction 308 for each video represented in the training dataset 228. For a given training iteration, the label predictions 308 generated by the untrained image-text classification model 302 are collectively represented as predictions 310.

For a detailed description of the untrained image-text classification model 302 generating predictions 310 during a training iteration, consider FIG. 4. As depicted in FIG. 4, training labels 402 are provided to the text encoder 304 of the untrained image-text classification model 302 during training. The training labels 402 are representative of labels included in the training dataset 228, such as labels 208 included in the pseudolabeled video dataset 216 and labels 226 included in the labeled video dataset 220. For each textual label included in the training labels 402, the text encoder 304 extracts a text representation. For instance, in the illustrated example of FIG. 4, training labels 402 include M different textual labels, where M represents any suitable integer, and text encoder 304 is configured to extract text representations 404 from the training labels 402, with each text representation represented by one of T₁, T₂, T₃ . . . T_{M}.

In a similar manner, training videos 406 are provided to the image encoder 306 of the untrained image-text classification model 302 during training. The training videos 406 are representative of videos included in the training dataset 228, such as unlabeled videos 204 included in the pseudolabeled video dataset 216 and videos 224 included in the labeled video dataset 220. For each video included in the training videos 406, the image encoder 306 extracts an image representation. To do so, the model training system 104 samples N frames from each video in the training videos 406 and provides the N frames for a video as input to the image encoder 306. N is representative of any suitable integer and the N frames represent either contiguous frames of the training video or non-contiguous frames of the training video. In some implementations, the N frames sampled from one of the training videos 406 are sampled in a uniform manner for each of the training videos 406. For instance, in an example implementation where four frames are sampled beginning at an elapsed playback time of five seconds for one of the training videos 406, the model training system 104 uniformly samples four frames beginning at an elapsed playback time of five seconds from each of the training videos 406.

In some implementations, the N frames are cropped before processing by the image encoder 306. For instance, in an example implementation each of the N frames is randomly cropped to a size of 244×244 pixels. In some implementations, at least some of the N frames are horizontally flipped prior to processing by the image encoder 306. For instance, the model training system 104 performs random horizontal flips of individual ones of the N frames before providing the N frames as input to the image encoder 306.

The image encoder 306 is configured to extract an image representation for each video frame provided as input. To compute an image representation for each of the training videos 406, the model training system 104 analyzes image representations extracted by the image encoder 306 for each of the N frames of the training video. The model training system 104 then average pools the resulting image representations generated by the image encoder 306 for the N frames of the training video into a single image representation for the training video. The resulting single image representation computed for each of the training videos 406 are represented in the illustrated example of FIG. 4 as image representations 408, with each image representation represented by one of I₁, I₂, I₃ . . . I_{M}.

Given the text representations 404 and the image representations 408, the model training system 104 tasks the untrained image-text classification model 302 with predicting a correct pairing of an image representation and a text representation pair using a contrastive objective, as described by van den Oord, et. al. Tasked with this objective, the untrained image-text classification model 302 compares individual ones of the text representations 404 with individual ones of the image representations 408 and computes a similarity score for each text representation and image representation pair. The resulting similarity scores are represented in table 410, where each cell in the table 410 includes a similarity score for an image representation and text representation pair.

For instance, the top row of table 410 represents similarity scores between the image representation I₁ and each of the text representations 404 T₁, T₂, T₃ . . . T_{M}. Thus, the top row of the table 410 is representative of a label prediction 308 for the training video represented by I₁. In a similar manner, the second row of the table 410 represents a label prediction 308 for the training video represented by I₂, the third row represents a label prediction for the training video represented by I₃, and so forth.

In some implementations, the entirety of the similarity scores represented in table 410 are output by the untrained image-text classification model 302 as the predictions 310 for a given training iteration. Alternatively, in some implementations only a top-ranked similarity score for each of the training videos 406 is output as the predictions 310 for the training video. For instance, in an example implementation where the I₁·T₃ similarity score in the top row and middle column of table 410 is identified as the top-ranked similarity score for the training video represented by I₁, the I₁·T₃ similarity score is output as the label prediction 308 for the training video instead of the entire top row of similarity scores.

During training, the predictions 310 are output by the untrained image-text classification model 302 to an evaluation module 312 of the model training system 104. The evaluation module 312 is configured to compare the predictions 310 against information included in the training dataset 228 and generate a loss function 314 based on the comparison. Specifically, the evaluation module 312 determines a contrastive loss 316 for predictions 310 generated from videos included in the labeled video dataset 220 and determines a distillation loss 318 for predictions 310 generated from videos included in the pseudolabeled video dataset 216.

When computing the contrastive loss 316, the evaluation module 312 implements Info Noise-Contrastive Estimation (InfoNCE) loss to learn video-text correspondence and minimizes both the text-to-video ( [symbol] ) and video-to-text ( [symbol] ) contrastive losses as expressed below:

$${ℒ}_{v 2 t} = {\sum }_{( v , t ) ∈ {B}_{l}} log \frac{{e}^{e} {z}_{v} \cdot {z}_{t}^{+} / σ}{{\sum }_{zϵ \{ {z}_{t}^{+} , {z}_{t}^{-} \}} {e}^{{z}_{v} \cdot z / σ}}$$

$${ℒ}_{t2 v} = {\sum }_{( v , t ) ∈ {B}_{l}} log \frac{{e}^{{z}_{t} \cdot {z}_{v}^{+} / σ}}{{\sum }_{zϵ \{ {z}_{v}^{+} , {z}_{v}^{-} \}} {e}^{e} {z}_{t} \cdot z / σ}$$

In the text-to-video ( [symbol] ) and video-to-text ( [symbol] ) contrastive losses expressed above, zᵥ represents the video representation extracted by the image encoder 306 (e.g., one of the image representations 408) and zₜ represents the text representation extracted by the text encoder 304 (e.g., one of the text representations 404) for a video-text pair denoted (v,t). Bₗ represents a batch of video-text pairs, which corresponds to the video-text pairs included in the labeled video dataset 220. zᵥ⁺ represents the positive video (e.g., the ground truth video) for the text representation zₜ and zₜ⁺ represents the positive label (e.g., the ground truth text label) for the video representation zᵥ.

Conversely, the sets of videos and labels represented by {zᵥ⁻, zₜ⁻} are the negative videos for the text representation zₜ and the negative text labels for the video representation zᵥ used to identify differences between text labels and video representations σ represents the temperature hyper-parameter. In some implementations, σ is 0.05. The final contrastive loss 316 for a training iteration is then represented as ( [symbol] + [symbol] ).

The distillation loss 318 represents knowledge gleaned from the pseudolabeled video dataset 216, where outputs generated by the pre-trained image-text classification model 108 are used to minimize the cross-entry of similarity scores represented in the predictions 310 relative to similarly scores represented in the pseudolabeled video dataset 216. Specifically, the evaluation module 312 computes text-to-video ( [symbol] ) and video-to-text ( [symbol] ) distillation losses as expressed below:

$$= {\sum }_{( v , t ) ∈ {B}_{l}} \frac{{e}^{{x}_{v} \cdot {x}_{t} / σ}}{{\sum }_{x ∈ T} {e}^{{x}_{v} \cdot x / σ}} log \frac{{e}^{{z}_{v} \cdot {z}_{t} / σ}}{{\sum }_{z ∈ T} {e}^{{z}_{v} \cdot z / σ}}$$

$${ℒ}_{distill , t 2 v} = {\sum }_{( v , t ) ∈ {B}_{l}} \frac{{e}^{{x}_{v} \cdot {x}_{t} / σ}}{{\sum }_{x ∈ V} {e}^{x \cdot {x}_{t} / σ}} log \frac{{e}^{{z}_{v} \cdot {z}_{t} / σ}}{{\sum }_{z ∈ V} {e}^{z \cdot {z}_{t} / σ}}$$

In the text-to-video ( [symbol] ) and video-to-text ( [symbol] ) distillation losses expressed above, xᵥ represents the image representation extracted by the image encoder 212 for a given unlabeled video 204 and xₜ represents the text representation extracted by the text encoder 210 for a given label 208. In the text-to-video ( [symbol] ) and video-to-text ( [symbol] ) distillation losses, Bₗ represents a batch of pseudolabeled videos included in the pseudolabeled video dataset 216, where V represents the set of unlabeled videos 204 and T represents the set of labels 208 included in the pseudolabeled video dataset 216.

The text-to-video ( [symbol] ) and video-to-text ( [symbol] ) distillation losses are scaled in the distillation loss 318 to prevent over-fitting to noise present in the pseudolabeled video dataset 216. Scaling the distillation losses is represented by λ, such that the distillation loss 318 is represented as λ( [symbol] + [symbol] ) In some implementations, λ is set as 0.999 to smooth the process of training the untrained image-text classification model 302. The resulting loss function 314 for a training iteration is represented as [symbol] =( [symbol] + [symbol] )+λ( [symbol] + [symbol] ). The model training system 104 then updates internal weights of the untrained image-text classification model 302 by applying the loss function 314 to the untrained image-text classification model 302. This process of causing the untrained image-text classification model 302 to generate predictions 310, determining loss function 314 by comparing the predictions 310 to the training dataset 228, and updating internal weights of the untrained image-text classification model 302 is repeated for a plurality of training iterations. In some implementations, the model training system 104 utilizes the AdamW optimizer with a learning rate equal to 3×10⁻⁵.

After completing the plurality of training iterations, the model training system 104 provides the trained version of the untrained image-text classification model 302 having internal weights influenced by the loss function 314 to ensemble module 320. The model training system 104 additionally provides the pre-trained image-text classification model 108 used to generate the pseudolabeled video dataset 216 as input to the ensemble module 320. The ensemble module 320 is representative of functionality of the model training system 104 to fuse internal weights of the trained instance of the untrained image-text classification model 302 with the internal weights of the pre-trained image-text classification model 108 to generate the video-text classification model 106.

By fusing the internal weights of the pre-trained image-text classification model 108 with the weights of the trained instance of the untrained image-text classification model 302, the ensemble module 320 leverages the general visual knowledge encoded in the pre-trained image-text classification model 108 along with the video-specific knowledge learned during training of the untrained image-text classification model 302 on the training dataset 228. The ensemble module 320 is configured to fuse the internal weights of the pre-trained image-text classification model 108 and the trained instance of the untrained image-text classification model 302 using any suitable model ensembling approach, such as the approaches described by Desai et al. in Learning Visual Representations from Textual Annotations, CVPR 2021.

In some implementations, the ensemble module 320 leverages weight-space ensembling techniques to linearly combine the internal weights of the pre-trained image-text classification model 108 with the internal weights of the trained instance of the untrained image-text classification model 302. For instance, the ensemble module 320 implements the linear combination approach described by Wortsman, et. al in Robust Fine-Tuning of Zero-Shot Models, arXiv 2109.01903, 2021, the disclosure of which is hereby incorporated by reference. In some implementations utilizing the linear combination approach described by Wortsman, et. al, the ensemble module 320 fuses the internal weights of the pre-trained image-text classification model 108 with the internal weights of the trained instance of the untrained image-text classification model 302 by α, where α=0.4.

The trained instance of the untrained image-text classification model 302, after having its internal weights fused with the internal weights of the pre-trained image-text classification model 108 is then output by the model training system 104 as the video-text classification model 106. The video-text classification model 106 is subsequently useable by the classification system 110 to output a video or text classification when provided a video or text input. As an example of the classification system 110 outputting a video or text classification for a video or text input, consider FIGS. 5 and 6.

In the illustrated example of FIG. 5, the video-text classification model 106 is depicted as generating a label 116 for an unlabeled video 112 input to the video-text classification model 106, demonstrating the video classification capabilities of the video-text classification model 106. Provided the unlabeled video 112 as input, the video-text classification model 106 processes the unlabeled video 112 using image encoder 502 to generate an image representation 504 of the unlabeled video 112. The video-text classification model 106 processes each frame of the unlabeled video 112 using the image encoder 502 and average-pools the outputs generated by the image encoder 502 to generate the image representation 504 of the unlabeled video.

The image encoder 502 represents an image encoder having a same architecture as the architecture of image encoder 212 and image encoder 306. The video-text classification model 106 compares the image representation 504 for the unlabeled video 112 to a plurality of text representations 506. The plurality of text representations generated by a text encoder 508 of the video-text classification model 106 are representative of a plurality of classifier labels 510, where each of the classifier labels 510 corresponds to one of the labels 208 or 226 learned from the training dataset 228 during training of the video-text classification model 106.

The video-text classification model 106 compares the image representation 504 to the text representations 506 and determines a similarity score for each combination of one of the text representations 506 and the image representation 504, collectively represented as the similarity scores 512. The similarity score indicating a greatest degree of similarity between the unlabeled video 112 and one of the text representations 506 is identified and used to select the classifier label corresponding to the one of the text representations 506. For instance, in the illustrated example of FIG. 5, the similarity score for the combination of image representation I₁ and text representation T₃ is shaded to indicate that the classifier label represented in latent space by the text representation T₃ is determined to be the most similar one of the classifier labels 510 to the visual content depicted in unlabeled video 112. The video-text classification model 106 is thus configured to output the classifier label corresponding to the text representation T₃, which is represented as label 116 in the illustrated example of FIG. 5.

In the illustrated example of FIG. 6, the video-text classification model 106 is depicted as outputting a video identified based on a text input 602, demonstrating the text-to-video retrieval capabilities of the video-text classification model 106. Given the text input 602, the video-text classification model 106 causes the text encoder 508 to generate a text representation 604 for the text input 602. The video-text classification model 106 then compares the text representation 604 to a plurality of image representations 606. The plurality of image representations 606 generated by the image encoder 502 are representative of a plurality of classifier videos 608, where each of the classifier videos 608 corresponds to one of the unlabeled videos 204 or videos 224 learned from the training dataset 228 during training of the video-text classification model 106.

The video-text classification model 106 compares the text representation 604 to the image representations 606 and determines a similarity score for each combination of one of the image representations 606 and the text representation 604, collectively represented as the similarity scores 610. The similarity score indicating a greatest degree of similarity between the text input 602 and one of the image representations 606 is identified and used to select the classifier video corresponding to the one of the image representations 606. For instance, in the illustrated example of FIG. 6, the similarity score for the combination of text representation T₁ and image representation I₁ is shaded to indicate that the classifier video represented in latent space by the image representation I₁ is determined to depict visual content most accurately described by the text input 602. The video-text classification model 106 is thus configured to output the classifier video corresponding to the image representation I₁, which is represented as video 612 in the illustrated example of FIG. 6.

In this manner, the video-text classification model 106 is configured to output a video or text classifying an input video or text by virtue of training dual text and image encoders to represent videos and text together in latent space. Having considered example systems and techniques, consider now example procedures to illustrate aspects of the techniques described herein.

### Example Procedures

The following discussion describes techniques that are configured to be implemented utilizing the previously described systems and devices. Aspects of each of the procedures are configured for implementation in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-6.

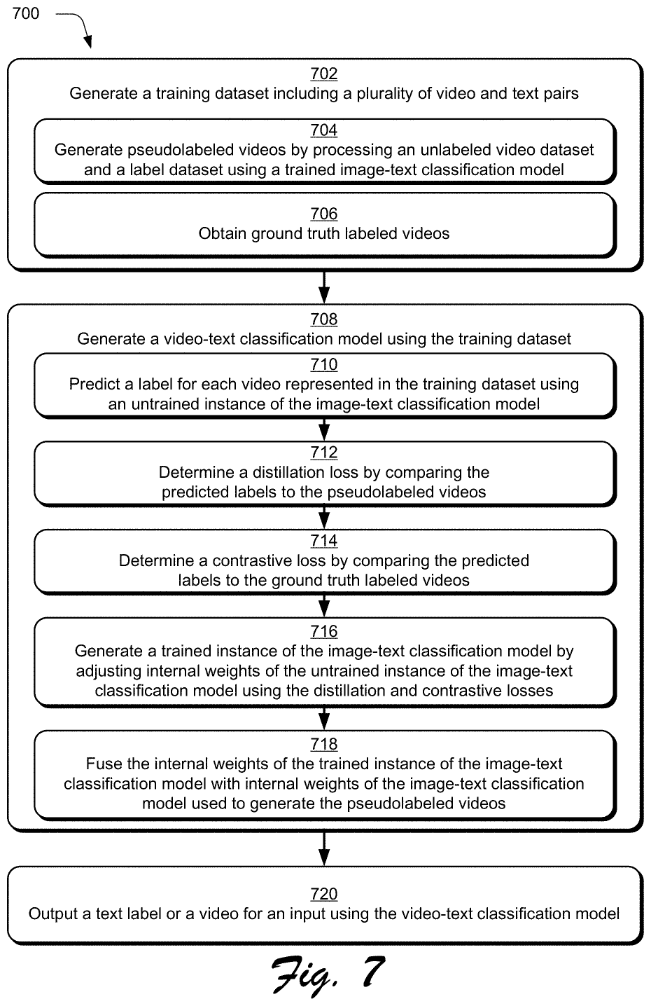

FIG. 7 is a flow diagram depicting a procedure 700 in an example implementation of generating a video-text classification model from a trained image-text classification model and using the video-text classification model to output a text label or a video for an input using the techniques described herein.

To begin, a training dataset including a plurality of video and text pairs is generated (block 702). As part of generating the training dataset, pseudolabeled videos are generated by processing an unlabeled video dataset and a label dataset using a trained image-text classification model (block 704). The model training system 104, for instance, obtains video dataset 202 including a plurality of unlabeled videos 204 and obtains label dataset 206 including a plurality of labels 208. The model training system 104 then processes the video dataset 202 and the label dataset 206 using the pre-trained image-text classification model 108 to generate the pseudolabeled video dataset 216.

As an additional part of generating the training dataset, ground truth labeled videos are obtained (block 706). The model training system 104, for instance, obtains labeled video dataset 220 that includes a plurality of labeled videos 222, where each labeled video 222 is representative of a video 224 with a label 226 known to accurately describe visual content depicted by the video 224. The model training system 104 generates the training dataset 228 to include both the pseudolabeled video dataset 216 and the labeled video dataset 220.

A video-text classification model is then generated using the training dataset (block 708). As part of generating the video-text classification model, a label is predicted for each video represented in the training dataset using an untrained instance of the image-text classification model (block 710). The model training system 104, for instance, provides the training dataset 228 as input to the untrained image-text classification model 302 and causes the untrained image-text classification model 302 to output a label prediction 308 for each video included in the training dataset 228.

As further part of generating the video-text classification model, a distillation loss is determined by comparing the predicted labels to the pseudolabeled videos (block 712). The evaluation module 312, for instance, compares label predictions 308 output by the untrained image-text classification model 302 for videos represented in the pseudolabeled video dataset 216 with the corresponding labels 208 assigned to the videos by the pre-trained image-text classification model 108 during generation of the pseudolabeled video dataset 216. The evaluation module 312 then computes the distillation loss 318 based on this comparison of the predictions 310 to the pseudolabeled video dataset 216.

As further part of generating the video-text classification model, a contrastive loss is determined by comparing the predicted labels to the ground truth labeled videos (block 714). The evaluation module 312, for instance, compares label predictions 308 output by the untrained image-text classification model 302 for videos 224 represented in the labeled video dataset 220 with the corresponding label 226 for each of the videos 224. The evaluation module 312 then computes the contrastive loss 316 based on this comparison of the predictions 310 to the labeled video dataset 220.

As further part of generating the video-text classification model, a trained instance of the image-text classification model is generated by adjusting internal weights of the untrained instance of the image-text classification model using the distillation and contrastive losses (block 716). The evaluation module 312, for instance, generates a loss function 314 using the contrastive loss 316 and the distillation loss 318 during each of a plurality of training iterations and the model training system 104 adjusts internal weights of the untrained image-text classification model 302 by applying the loss function 314 during each of the plurality of training iterations. In some implementations, the model training system 104 continues performing the plurality of training iterations until determining that the predictions 310 output by the untrained image-text classification model 302 achieve a threshold similarity to one or more of the labeled video dataset 220 or the pseudolabeled video dataset 216 included in the training dataset 228.

As further part of generating the video-text classification model, the internal weights of the trained instance of the image-text classification model are fused with internal weights of the image-text classification model used to generate the pseudolabeled videos (block 718). The ensemble module 320, for instance, receives the trained instance of the untrained image-text classification model 302 following completion of the plurality of training iterations and fuses internal weights of the trained instance of the untrained image-text classification model 302 with internal weights of the pre-trained image-text classification model 108. The ensemble module 320 then outputs the video-text classification model 106 as a result of combining the internal weights of the trained instance of the untrained image-text classification model 302 and the pre-trained image-text classification model 108.

A text label or a video for an input is then output using the video-text classification model (block 720). The classification system 110, for instance, inputs an unlabeled video 112 to the video-text classification model 106 and causes the video-text classification model 106 to output a label 116 for the unlabeled video 112. Alternatively or additionally, the classification system 110 provides a text input 602 to the video-text classification model 106 and causes the video-text classification model 106 to output a video 612 based on the text input 602.

Having described example procedures in accordance with one or more implementations, consider now an example system and device to implement the various techniques described herein.

### Example System and Device

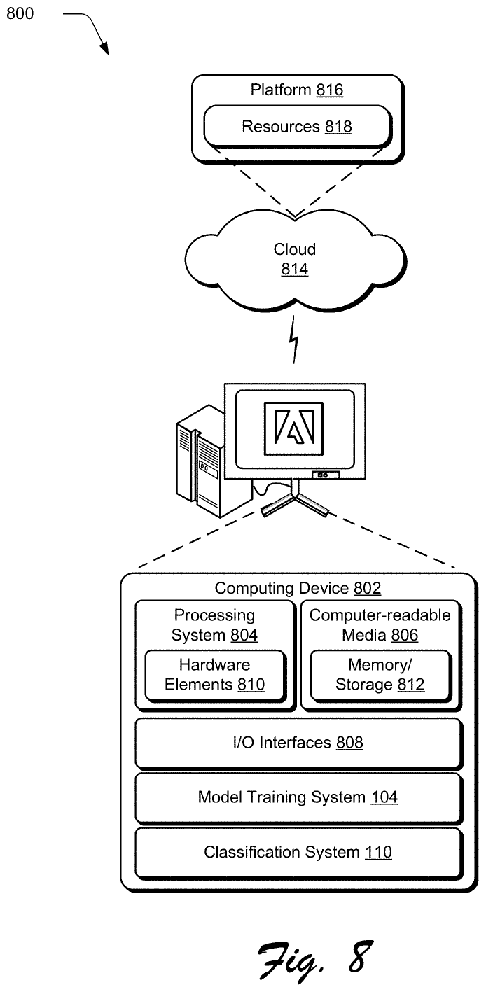

FIG. 8 illustrates an example system 800 that includes an example computing device 802, which is representative of one or more computing systems and/or devices that implement the various techniques described herein. This is illustrated through inclusion of model training system 104 and the classification system 110. The computing device 802 is configured, for example, as a service provider server, as a device associated with a client (e.g., a client device), as an on-chip system, and/or as any other suitable computing device or computing system.

The example computing device 802 as illustrated includes a processing system 804, one or more computer-readable media 806, and one or more I/O interface 808 that are communicatively coupled, one to another. Although not shown, the computing device 802 is further configured to include a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that are configurable as processors, functional blocks, and so forth. For instance, hardware element 810 is implemented in hardware as an application specific integrated circuit or other logic device formed using one or more semiconductors. The hardware elements 810 are not limited by the materials from which they are formed, or the processing mechanisms employed therein. For example, processors are alternatively or additionally comprised of semiconductor(s) and/or transistors (e.g., electronic integrated circuits (ICs)). In such a context, processor-executable instructions are electronically executable instructions.

The computer-readable storage media 806 is illustrated as including memory/storage 812. The memory/storage 812 represents memory/storage capacity associated with one or more computer-readable media. The memory/storage 812 is representative of volatile media (such as random-access memory (RAM)) and/or nonvolatile media (such as read only memory (ROM), Flash memory, optical disks, magnetic disks, and so forth). The memory/storage 812 is configured to include fixed media (e.g., RAM, ROM, a fixed hard drive, and so on) as well as removable media (e.g., Flash memory, a removable hard drive, an optical disc, and so forth). In certain implementations, the computer-readable media 806 is configured in a variety of other ways as further described below.

Input/output interface(s) 808 are representative of functionality to allow a user to enter commands and information to computing device 802 and allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., a device configured to employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is representative of a variety of hardware configurations as further described below to support user interaction.

Various techniques are described herein in the general context of software, hardware elements, or program modules. Generally, such modules include routines, programs, objects, elements, components, data structures, and so forth that perform particular tasks or implement particular data types. The terms “module,” “functionality,” and “component” as used herein generally represent software, firmware, hardware, or a combination thereof. The features of the techniques described herein are platform-independent, meaning that the techniques are configured for implementation on a variety of commercial computing platforms having a variety of processors.

An implementation of the described modules and techniques are stored on or transmitted across some form of computer-readable media. The computer-readable media include a variety of media that is accessible by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 802, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that is employed in some embodiments to implement at least some aspects of the techniques described herein, such as to perform one or more instructions. Hardware, in certain implementations, includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are employed to implement various techniques described herein. Accordingly, software, hardware, or executable modules are implemented as one or more instructions and/or logic embodied on some form of computer-readable storage media and/or by one or more hardware elements 810. The computing device 802 is configured to implement instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supported by various configurations of the computing device 802 and are not limited to the specific examples of the techniques described herein. This functionality is further configured to be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that is utilized while computer processing is executed on servers that are remote from the computing device 802. Resources 818 also include services provided over the Internet and/or through a subscriber network, such as a cellular or Wi-Fi network.

The platform 816 is configured to abstract resources and functions to connect the computing device 802 with other computing devices. The platform 816 is further configured to abstract scaling of resources to provide a corresponding level of scale to encountered demand for the resources 818 that are implemented via the platform 816. Accordingly, in an interconnected device embodiment, implementation of functionality described herein is configured for distribution throughout the system 800. For example, in some configurations the functionality is implemented in part on the computing device 802 as well as via the platform 816 that abstracts the functionality of the cloud 814.

Although the invention has been described in language specific to structural features and/or methodological acts, the invention defined in the appended claims is not necessarily limited to the specific features or acts described. Rather, the specific features and acts are disclosed as example forms of implementing the claimed invention.

What is claimed is:

1. A method comprising:
obtaining a training dataset that includes a plurality of videos and a plurality of text labels; and
generating a video-text classification model by:
causing a machine learning model to predict, for each of the plurality of videos, which of the plurality of text labels describes visual content depicted by the video;
adjusting internal weights of the machine learning model using a loss function that is determined by comparing the predictions generated by the machine learning model to the training dataset;
obtaining a trained image-text classification model having a same architecture as the machine learning model; and
combining the adjusted internal weights of the machine learning model with internal weights of the trained image-text classification model.

2. The method of claim 1, wherein the plurality of videos and the plurality of text labels include a plurality of pseudolabeled videos generated by inputting a plurality of unlabeled videos and a plurality of labels to the trained image-text classification model and tasking the trained image-text classification model with predicting which of the plurality of labels describe each of the plurality of unlabeled videos.

3. The method of claim 1, wherein the plurality of videos and the plurality of text labels include a plurality of ground truth labeled videos that each have an accurate textual description of visual content depicted in the ground truth labeled video.

4. The method of claim 1, wherein the plurality of videos each depict a human performing an action and at least some of the plurality of text labels include textual descriptions of actions.

5. The method of claim 1, wherein the trained image-text classification model and the machine learning model are each configured with an image encoder and text encoder architecture.

6. The method of claim 1, wherein causing the machine learning model to predict which of the plurality of text labels describes visual content depicted by each of the plurality of videos comprises inputting the plurality of videos and the plurality of text labels to the machine learning model without indicating a correlation between the plurality of text labels and the plurality of videos as represented in the training dataset.

7. The method of claim 1, wherein causing the machine learning model to predict which of the plurality of text labels describes visual content depicted by each of the plurality of videos comprises tasking the machine learning model with a contrastive objective.

8. The method of claim 1, wherein the loss function includes a contrastive loss that is computed by:
identifying ground truth pairs in the training dataset, each of the ground truth pairs including one of the plurality of videos and one of the plurality of text labels;
identifying predictions generated by the machine learning model for each of the plurality of videos included in the ground truth pairs; and
comparing the predictions generated by the machine learning model for each of the plurality of videos included in the ground truth pairs to a corresponding one of the plurality of text labels included in the ground truth pair.

9. The method of claim 1, wherein the loss function includes a distillation loss that is computed by:
inputting a plurality of unlabeled videos and a plurality of text labels to the trained image-text classification model and tasking the trained image-text classification model with predicting which of the plurality of text labels describes each of the plurality of unlabeled videos;
generating a pseudolabeled video dataset based on predictions output by the trained image-text classification model, wherein the training dataset includes the pseudolabeled video dataset;
identifying predictions generated by the machine learning model for each of the plurality of videos included in the pseudolabeled video dataset; and
comparing the predictions output by the machine learning model for each of the plurality of videos included in the pseudolabeled video dataset with the predictions output by the trained image-text classification model.

10. The method of claim 1, wherein causing the machine learning model to predict, for each of the plurality of videos, which of the plurality of text labels describes visual content depicted by the video and adjusting the internal weights of the machine learning model using the loss function is repeated for a plurality of training iterations.

11. The method of claim 1, wherein the trained image-text classification model is trained to identify similarities between text descriptions and visual content depicted in images on a training dataset that includes text and images and does not include video.

12. The method of claim 1, wherein causing the machine learning model to predict, for each of the plurality of videos, which of the plurality of text labels describes visual content depicted by the video comprises sampling a subset of frames from the video and causing the machine learning model to predict which of the plurality of text labels describes each of the subset of frames from the video.

13. The method of claim 12, further comprising average-pooling predictions output by the machine learning model for each of the subset of frames from the video to a single prediction describing which of the plurality of text labels describes the visual content depicted by the video.

14. The method of claim 1, further comprising:
causing the video-text classification model to output a textual description for an unlabeled video provided as input to the video-text classification model; or
causing the video-text classification model to output a video depicting visual content described by text provided as input to the video-text classification model.

15. A non-transitory computer-readable storage medium storing executable instructions, which when executed by a processing device, cause the processing device to perform operations comprising:
receiving a video-text classification model generated by combining internal weights of a trained image-text classification model having an image encoder and text encoder architecture with internal weights of a machine learning model having the image encoder and text encoder architecture, the machine learning model being trained using contrastive loss and distillation loss; and
causing the video-text classification model to generate an output that classifies digital content by inputting the digital content to the video-text classification model.

16. The non-transitory computer-readable storage medium of claim 15, wherein the contrastive loss used to train the machine learning model is computed by:
inputting a plurality of videos and a plurality of text labels to the machine learning model and causing the machine learning model to predict which of the plurality of text labels describes each of the plurality of videos;
obtaining a labeled dataset that describes which of the plurality of text labels describes each of the plurality of videos; and
comparing predictions output by the machine learning model with the labeled dataset.

17. The non-transitory computer-readable storage medium of claim 15, wherein the distillation loss used to train the machine learning model is computed by:
inputting a plurality of unlabeled videos and a plurality of text labels to the trained image-text classification model and tasking the trained image-text classification model with predicting which of the plurality of text labels describes each of the plurality of unlabeled videos;
generating a pseudolabeled video dataset based on predictions output by the trained image-text classification model;
causing the machine learning model to predict which of the plurality of text labels describes each of the plurality of videos; and
comparing predictions output by the machine learning model with the predictions output by the trained image-text classification model.

18. The non-transitory computer-readable storage medium of claim 15, wherein the digital content comprises a video and the output comprises a text label for the video.

19. The non-transitory computer-readable storage medium of claim 15, wherein the digital content comprises text and the output comprises a video that depicts visual content described by the text.

20. A system comprising:
a memory component; and
a processing device coupled to the memory component, the processing device to perform operations comprising:
obtaining a training dataset that includes a plurality of videos and a plurality of text labels; and
generating a video-text classification model by:
causing a machine learning model to predict, for each of the plurality of videos, which of the plurality of text labels describes visual content depicted by the video;
adjusting internal weights of the machine learning model using a loss function that is determined by comparing the predictions generated by the machine learning model to the training dataset;
obtaining a trained image-text classification model having a same architecture as the machine learning model; and
combining the adjusted internal weights of the machine learning model with internal weights of the trained image-text classification model.
